(19) United States
(12) Patent Application Publication
(10) Pub. No.: US 2025/0110293 A1
(43) Pub. Date: Apr. 3, 2025

(54) SEE THROUGH DISPLAY

(71) Applicant: KDH Advanced Research Pty Ltd, Balwyn North (AU)

(72) Inventors: Ranjith RAJASEKHARAN, Balwyn North (AU); Wei-Young LIANG, Balwyn North (AU)

(21) Appl. No.: 18/729,836

(22) PCT Filed: Jan. 17, 2023
(86) PCT No.: PCT/AU2023/050021

§ 371 Date: Jul. 17, 2024

(30) Foreign Application Priority Data
Jan. 17, 2022 (AU) 2022900077

(51) Int. Cl. G02B 6/42; G02B 27/01

(52) U.S. Cl. CPC G02B 6/4214; G02B 27/0172

(57) ABSTRACT

The present invention relates to a see-through display, comprising at least one light guiding apparatus, comprising a light transmitting substrate having a first edge, a second edge and a surface between the edges, and a plurality of light transflectors disposed on the surface or within the light transmitting substrate. A light valve is stacked on the surface of and optically connected with the at least one light guiding apparatus. At least one light source is adjacent to the first edge and optically connected with the at least one light guiding apparatus in order to transmit a light from the light source along a light path from the first edge towards the second edge. When in use, each light transflector is configured to reflect a portion of the light away from the light path and to optionally transmit the other portion of the light along the light path.

### TECHNICAL FIELD

The present invention relates, in general terms, to a see through optical display. The see through optical display can directing a light from a light source to an eye of a user. The present invention also relates to a light guiding apparatus and a guiding method thereof.

### BACKGROUND

Augmented Reality (AR) is an emerging technology that enables the seamless overlay of the real world with computer generated virtual images in such a way that the virtual content is aligned with real world objects. The main part of any AR device is a display through which a viewer can see virtual content and real world objects at the same time. The virtual content can be overlaid over a physical object and in some cases can interact with the physical object. AR is now being targeted in a wide range of application domains, including education (interactive learning and teacher training), medicine (image guided surgery and surgical simulation), consumer products (head up displays for helmets and AR spectacles), industrial (architectural planning and object assembly), and entertainment (AR tourism and storytelling).

Despite AR promising to provide breakthrough visual experience in numerous applications, it has to date failed to receive widespread adoption due to discomfort, eyestrain and cumbersome devices. These drawbacks are threatening growth in this market that has the potential to grow to US$100 billion by 2024.

A traditional projection imaging method projects the light beam to the image-receiving object through air as a medium. The advantage of this method is high brightness of the light beam arriving at the image-receiving object and low consumption of light energy. However, this method allows the light beam to travel only in a straight line, which limits the installation flexibility of a light source in a space-limited apparatus. To make the light beam change the traveling direction, additional reflective structures can be placed on the light path to change the direction of the light path. However, the disposition of the additional reflective structures causes some problems such as higher manufacturing cost, production difficulties, complex design, and increased size. Another traditional projection imaging method guides the light beam through the grating or hologram treatments by diffraction, not constrained by the straight movement, which decreases the brightness of the light beam arriving at the image-receiving object, consumes more light energy and can result in a loss of data. Consequently, the designs of the power supply and the heat dissipation mechanism become difficult. Furthermore, gating/hologram based designs are wavelength (colour) sensitive. In addition, the interference may be caused as the light beams travels along the light path and creates difficulty in design and mass production regarding the optical grade carrier material and forming structures, unfavourable for the imaging and display quality.

The slow uptake of AR by the public is mainly caused by the physical form of current AR devices, which require the viewer to look through thick cube shaped combiners, a limited field of view and an eye box that limit movement of the eyes and obstructs peripheral vision. This glass-based box display technology demands micro-display and coupling optics to be integrated to the viewing glass on either side of the eyes and that makes the system bulky around the eyes in addition to blocking the side view.

For example, light from a micro-display can be coupled to glass. However, since the conventional optical design of AR display requires straight light which leads to the combiner part cannot be bent, this demands that the display and electronics always need to be placed near or around the viewing area such as our eyes. This results in a heavy and bulky viewing side, which prevents their wide usage. For example, when used in spectacles, this causes the spectacles to be ‘front’ heavy, which causes discomfort to the area around the nose bridge. Furthermore, viewing angle is limited in the conventional glass based technology and also efficiency of light coupling is very less which prevents seeing in bright light conditions.

The strive for compactness has led to several different complex optical solutions, all of which, on the one hand, are still not sufficiently compact for most practical applications, and, on the other hand, suffer major drawbacks in terms of manufacturability.

Another technology uses a curved partial reflector acting both as a magnifying optics and a combiner and this eliminates the need of additional magnifying optics. This technology is used in DreamGlass. However, the curved mirror distorts the see-through images from the real world and harms the transparency.

Another implementation uses a discontinuous geometric optical coupling design, which leads to an increase in the thickness of the combiner and a low production yield.

Another technology uses a glass wafer of thickness around 5 mm as a waveguide to propagate the light (image). However, this design sacrifices the field of view (FOV) due to the limited angular range. There is also a discontinuity in the image when the eyeball moves within the eye box due to the difficulty of integrating reflectors precisely inside the glass with less than a few mm spacing and alignment errors. This creates ghost images and stray reflections.

Another AR display technology uses holograms or gratings to couple out the light into viewer's eyes. However, this emerging technology requires more research to make it work efficiently (in terms of energy loss from diffraction leading to very low brightness) for all the visible wavelengths (colours). Diffraction-based technique requires RGB specific treatments over the micro structure and complexity in fabrication.

Another problem relates to the display panel. FIG. 1 shows the conventional opaque liquid crystal panel with various backlights as light sources. The backlights can be reflected using a reflector to the LCD panel. The operation of the backlight is to produce uniform monochromatic or polychromatic light in the entire active display range through the diffuser, which is not transparent, no matter whether the design is a direct-lit backlight or an edge-lit backlight. If white light is used as the backlight, each display pixel has its own specific color which is created by color filters to divide and form an array of R-G-B-3 individual sub-pixels. The image is formed on the LCD panel by switching on and off electrodes using thin film transistor technology (TFT) to allow or block the transmitted light. The switching on or off of the transmitted light is required to operate in individual sub-pixels, and the degree of gradation (taking 24-bit color depth as an example, 256-step opening control is required for each color channel) between the switching must be able to control properly. In order to achieve this mechanism, a bias voltage control circuit with capacitor components accordingly is used that can manage at least three times the total number of display pixels, considering also the sophisticated switching control behaviour (which also increases the complexity of the driver IC). The layout of the transparent control circuits printed on the panel requires more line width and hence leave less space for the pixels and colour filters which in terms reduces luminous flux from the color filters. The resolution or brightness will consequently be compromised from display experience's perspective.

Additionally, the display technologies in FIG. 1 cannot be used in AR due to the ‘opaque’ illumination technology by the backlight, color filters and polarizers which are stacked on top of the LCD panel along with other optical elements.

It would be desirable to overcome or ameliorate at least one of the above-described problems.

### SUMMARY

The present invention relates to a see through optical display which uses an array of semi-transparent reflectors (or transflector) on a flexible or rigid matrix, and optically connected with optical elements and driving schemes for generating high efficient images on a see-through transparent pane for augmented reality (AR) applications. To this end, it is envisioned that a display can be made see through when fitted with transflectors as reflective pixels that can reflect images to a user's eye and a waveguide for guiding light from a light source. A see-through effect from a lateral side of the waveguide to another lateral side can be obtained. At the same time the light beam arriving from the image-receiving object can have a high brightness with low consumption of light energy, enhanced field of view, sharpness and can reduce strain to the eyes. The optical display can be incorporated as a component in near field applications such as a spectacle or on a helmet or far field applications such as car windscreen, TV screen, computer/mobile screen and windows. For example, because the electronics can be positioned at a distance away from the display, spectacles are ‘end’ heavy, and thus improve comfort for the user.

The present invention relates to a see-through display, comprising:
a) at least one light guiding apparatus, comprising:
   i) a light transmitting substrate having a first edge, a second edge and a surface between the edges; and
   ii) a plurality of transflectors disposed on the surface or within the light transmitting substrate;
b) a light valve stacked on the surface of the light guiding apparatus and optically connected with the at least one light guiding apparatus; and
c) at least one light source adjacent to the first edge of the light transmitting substrate and optically connected with the at least one light guiding apparatus in order to transmit a light from the light source along a light path from the first edge towards the second edge;
   wherein when in use, each transflector is configured to reflect a portion of the light away from the light path and to optionally transmit the other portion of the light along the light path.

Advantageously, by positioning the light source at an edge of the light guiding apparatus and hence at an edge of the see through display, the display can be sufficiently lit up through the transmission of light via the transflectors. Each transflector serves as a light pixel to provide a one-on-one direct mapping of the specific light beam generated from the light source onto the light valve. An image can be formed by the reflected light from the light transflectors working in conjunction with the light valve. As the conventional opaque backlight (and corresponding diffuser, mirrors and reflective layers) is removed, the display is consequently made see through.

In some embodiments, each transflector is independently at an angle relative to the surface.

In some embodiments, each transflector is independently at an angle of about 5° to about 80° relative to the surface.

In some embodiments, each transflector independently comprises a boundary selected from a metal-polymer boundary, an air-polymer boundary, an air-metal boundary, a material-polymer boundary, or a combination thereof, the material having a lower refractive index than the polymer.

In some embodiments, the plurality of transflectors is a one dimensional, two dimensional or three dimensional array of light transflectors.

In some embodiments, when in use, each transflector is dimensioned to correspond to a pixel in a formable image.

In some embodiments, each transflector extends between a third edge and a fourth edge, the third and fourth edges transverse to the first edge.

In some embodiments, each transflector is a triangular prism.

In some embodiments, the transflectors are separated by a pitch of about 0 mm to about 5 mm.

In some embodiments, the transflectors are separated by an edge to edge spacing of about 30 μm to about 300 μm.

In some embodiments, each transflector independently has a width of about 10 μm to about 10 mm.

In some embodiments, each transflector independently has a length of about 1 μm to about 10 mm.

In some embodiments, each transflector independently has a height of about 30 μm to about 300 μm.

In some embodiments, each transflector comprises a gas, air or a light transmitting polymer.

In some embodiments, each air-metal boundary comprises a metal with a thickness of about 3 nm to about 800 μm.

In some embodiments, each air-metal boundary comprises a metal selected from gold, silver, aluminium, chromium, copper, nickel, platinum or their combination thereof.

In some embodiments, each boundary independently comprises an array of nanostructures and/or microstructures.

The array of nanostructures and/or microstructures allows light to be reflected to a viewer's eye and at the same time allows for transparency.

In some embodiments, each of the nanostructures and/or microstructures is disposed at an angle of about 5° to about 80° relative to planar surface.

In some embodiments, each of the nanostructures and/or microstructures independently has a thickness of about 4 nm to about 500 μm.

In some embodiments, each of the nanostructures and/or microstructures independently has a width of about 1 μm to about 1000 μm.

In some embodiments, each of the nanostructures and/or microstructures independently has a pitch of about 1 μm to about 1000 μm.

In some embodiments, the light transmitting substrate comprises a light transmitting polymer or glass.

In some embodiments, the light transmitting polymer is selected from polydimethylsiloxane (PDMS), polycarbonate, polyester, acrylic such as poly(methyl methacrylate), polyethylene terephthalate (PET), polyimide (PI), polyethersulfone (PES), their derivatives and combinations thereof.

In some embodiments, the light transmitting substrate has a cross sectional thickness of about 1 μm to about 10 mm.

In some embodiments, the light transmitting substrate has a flexural modulus of less than about 4 GPa.

In some embodiments, the light transmitting substrate is characterised by a light transmittance transverse to the planar surface of at least 85%.

In some embodiments, the light guiding apparatus is characterised by an absence of a cladding layer on its planar surface.

In some embodiments, the light guiding apparatus is characterised by an absence of a buffer layer on its planar surface.

In some embodiments, the at least one light guiding apparatus is contacted with a first planar surface of the light valve.

In some embodiments, the light valve comprises a liquid crystal layer sandwiched between two electrode layers.

In some embodiments, the electrode layer comprises indium tin oxide (ITO) and/or silicon on glass.

In some embodiments, the see-through display further comprises a first polarizer stacked on the light valve, the polarizer optically connected with the light valve. The first polarizer may be stacked on a surface of the light valve.

In some embodiments, the first polariser is contacted with a second surface of the light valve.

In some embodiments, the at least one light source is selected from a MEMS powered beam scanning engine, a linear array of lasers, LEDs, or a combination thereof.

In some embodiments, the light source further comprises a brightness enhancement film (BEF), duel brightness enhancement film (DBEF), a light diffuser, or a combination thereof.

In some embodiments, the see through display further comprises a light transmitting polymer guide between the at least one light source and the edge of the light transmitting substrate, the polymer guide optically connected with the light source and the light guiding apparatus.

In some embodiments, the see-through display further comprises a second polarizer between the at least one light source and the first edge of the light transmitting substrate, the polarizer optically connected with the light source and the light guiding apparatus.

Advantageously, positioning the second polariser away (not on the viewing optical axis of the display plane) from the liquid crystal panel but still optically connected improves the transmission efficiency of the display and hence the transparency.

In some embodiments, the first polariser and the second polariser are crossed polarised.

In some embodiments, the see-through display further comprises control electronics for controlling the light source.

In some embodiments, each transflector is addressed by sequentially scanning the transflectors line-by-line or by a matrix addressing method.

In some embodiments, the see through display further comprises optical coupling means for coupling light from light source to the light guiding apparatus.

In some embodiments, the see-through display is characterised by an absence of colour filter adjacent to the light guiding apparatus.

In some embodiments, the see through display is characterised by a light transmittance transverse to the planar surface of at least 85%.

The present invention also relates to a method of fabricating a see-through display, comprising:
a) stacking a light valve on a surface of at least one light guiding apparatus such that the light valve is optically connected with the at least one light guiding apparatus, the at least one light guiding apparatus comprising:
   i) a light transmitting substrate comprising a first edge, a second edge and a surface between the edges; and
   ii) a plurality of transflectors disposed on the surface or within the light transmitting substrate; and
b) disposing at least one light source adjacent to the first edge of the light transmitting substrate and optically connected with the at least one light guiding apparatus in order to transmit a light from the light source along a light path from the first edge towards the second edge;
   wherein when in use, each transflector is configured to reflect a portion of the light away from the light path and to optionally transmit the other portion of the light along the light path.

### BRIEF DESCRIPTION OF THE DRAWINGS

Embodiments of the present invention will now be described, by way of non-limiting example, with reference to the drawings in which:

FIG. 1 shows schemes of existing display illuminations, where 101 is a light diffusion plate, 102 is a light mixed zone, 103 is light mirrors, 104 is a brightness-enhancement film (BEF), 105 is a LCD panel with polariser and analyser, 106 is a light guide plate;

FIG. 2A is a perspective view of the see-through display, where the light source 208 coupled in to the substrate 212 from a side of the substrate and the couple-out direction be towards the other side of the substrate 212;

FIG. 2B is a side view of the see-through display;

FIG. 3 is a side view of a light guiding apparatus according to an embodiment of the present invention;

FIG. 4 shows front views and cross sectional view of the light guiding apparatus;

FIG. 5 is a schematic drawing of the see-through display;

FIG. 6 is a drawing showing light guiding apparatus with air filled or nanoscale thick metallic transflectors and microstructures;

FIG. 7 shows an array of transflectors;

FIG. 8 shows how light is reflected from the transflectors;

FIG. 9 shows an illumination arrangement where two light sources are placed on the left and right of the edge of the light guiding apparatus;

FIG. 10 shows multilayers of light guiding apparatus;

FIG. 11 shows schematics and photos of transflectors with varying sizes and pitches;

FIG. 12 shows an example of the see-through display in use;

FIG. 13 is a photo of the see-through display compared with other displays;

FIG. 14 shows the light guiding apparatus in use with white light or laser light; and

FIG. 15 is a flow chart of a method of fabricating the see-through display.

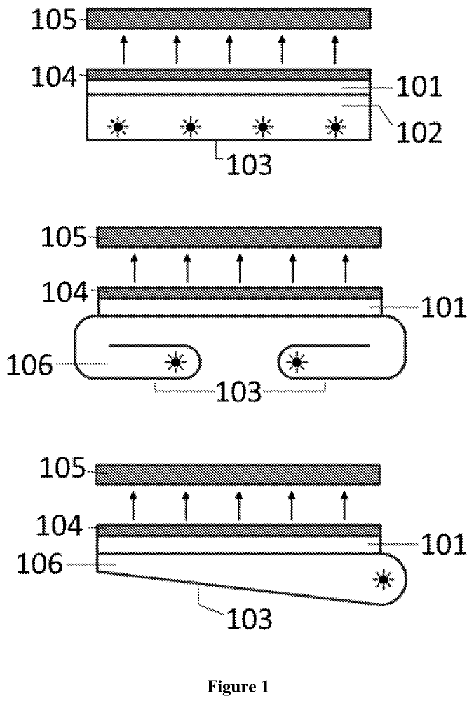

### DETAILED DESCRIPTION

The present invention relates to a see-through display, comprising:
a) at least one light guiding apparatus, comprising:
   i) a light transmitting substrate having a first edge, a second edge and a surface between the edges; and
   ii) a plurality of transflectors disposed on the surface or within the light transmitting substrate;
b) a light valve stacked on the surface of the light guiding apparatus and optically connected with the at least one light guiding apparatus; and
c) at least one light source adjacent to the first edge of the light transmitting substrate and optically connected with the at least one light guiding apparatus in order to transmit a light from the light source along a light path from the first edge towards the second edge;
   wherein when in use, each transflector is configured to reflect a portion of the light away from the light path and to optionally transmit the other portion of the light along the light path.

The term “transflector” is used to refer to an optical component that reflects light incident on one of its surfaces at a particular reflected exit angle, and/or at the same time, the optical component transmits rays incident on another surface at a particular transmitted exit angle. “Reflector” is a subset of “transflector” with reflection set to 100% and transmission set to 0%. For example, the transflector closest to the second edge of the light guiding apparatus (the last transflector) can be a reflector so as to maximise the light output and improve image quality.

The presently disclosed see-through display allows for light to be transmitted throughout the light valve via the light guiding apparatus. By having the transflectors each independently at various angles for transmitting light via the light path within or on the light transmitting substrate, the viewing angle is increased. The transflectors are appropriately sized such that each acts as a light pixel. As light from the light source is only reflected at each transflector (acting as a light pixel), pixelated light is homogenously provided to the light valve. The totality of the light pixels can be recomposed to form a spectral uninverted image (imaging that uses multiple bands across the electromagnetic spectrum) by the passing of the reflected light from the light pixels through the light valve. In this way, as the light guiding apparatus only handles light pixels, a constant brightness, consistent colour and wavelength of light throughout the see-through display can be obtained, which provides for a uniform image as the light is passed through the light valve. Further, more information can be relayed to a viewer's eye as the image can be coloured. A better image quality can be received at the viewer's eye which is suitable for outdoor use where there is a high background noise. This is in contrast to prior waveguides powered by microstructures designed for specific wavelengths, each layered waveguide can only process a specific color light, which only allows for a monotonous colour, is excessively bright and has a large light loss.

In some embodiments, the transreflector (light pixel) can illuminate multiple light valves. Furthermore, a beam shaping or a diffuser plate can be used between the light valves and the transreflectors.

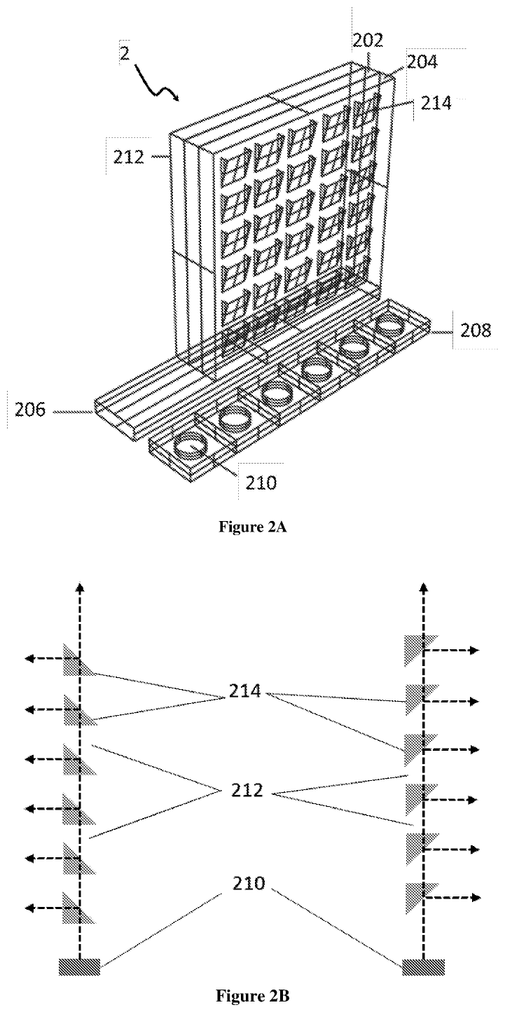

Compared with conventional display panel methods such as liquid crystal display or micro-LED/OLED display, in which the backlight or self-luminous parts must be deployed in uniform distribution on the entire display area, the present invention provides an advantage that the light source functionality is removed (or remote) from the display panel. For example, this allows the light source (built up by diode) to be built with a larger sized component (below the display as shown in FIG. 2) by using higher-brightness light-emitting elements, so that the brightness will not be compromised by increasing the resolution. Furthermore, the display panel can be made thin, transparent and lightweight.

Advantageously, by positioning the light source at the edge of the light guiding apparatus and hence at an edge of the see through display, the display can be sufficiently lit up through the transmission of light via the transflectors. An image (real/virtual) can be formed from the reflected light of the transflectors and the workings of the light valve. As the backlight (and corresponding diffuser, mirrors and reflective layers) is removed, the display is see through.

More advantageously, compared with conventional self-luminous display panel methods such as micro-LED/OLED display in the case of semi transparent display (which still has a hazy hue in the screen), black colour is managed by dimming the self-luminous components however the ambient light can still be penetrated (through the holes left around the self-luminous components) from the back side of the transparent display which leads to poor contrast ratio given by that the rendering of black colour is not black enough. In this present invention, the black colour is done by the light valve 202 mechanism; consequently the unwanted light penetrated from the other side of the transparent display can be blocked hence a better black colour regeneration can be achieved.

FIGS. 2A and 2B shows a perspective view and a side view of a see through display 2. In order to clearly indicate the structure of the light path working individually and independently, the reflective microstructures between the optical channels are disconnected (in the real implementation, they can be jointly connected with each other) as illustrated. The see-through display 2 comprises a light guiding apparatus having a light transmitting substrate 212 and a plurality of light transflectors 214. The light guiding apparatus is adjacently stacked with a light valve 202. The light valve can be a liquid crystal layer sandwiched between two electrode layers. The light valve 202 is optically connected with the at least one light guiding apparatus. In this regard, when light from the light source is reflected by the light transflectors, the light is directed towards and through the light valve 202. Towards this end, the reflected light is reflected such that it is no longer parallel (and can be additionally perpendicular) to the surface. The light valve 202 serves to define the image to be formed by selectively blocking the reflected light from each light transflectors (acting as light pixels). A first polariser 204 can optionally be stacked on the other surface of the light valve 202. Adjacent at an edge of the light guiding apparatus is at least one light source 208. The light source 208 is optically connected with the at least one light guiding apparatus at an edge. The light source 208 can be a linear light source. The light source 208 can further comprise a plurality of light modules of different wavelengths 210. For example, the light module 210 can be a laser or LED diode-based module, or a light beam generated by a laser scanning engine. A second polariser 206 can optionally be positioned adjacent to the edge of the light guiding apparatus. The light source 208 is optically connected with the second polariser 206. In this regard, the light source 208 can be positioned at any position relative to the second polariser 206 as long as they are optically connected, for example through the use of mirrors or lens. For clarity, FIG. 2A shows the second polariser 206 and light source 208 are positioned beside each other (and without optical connecting means). The light guiding apparatus, light valve 202 and optionally the first polariser 204 form a see-through display panel or screen from which a viewer can observe real objects via light transmitted transversely through the screen. The viewer can also observe real or virtual images via light reflected by the light guiding apparatus and defined by the light valve 202. By positioning the second polariser away from the viewing surface of the light valve, the transparency of the see through display is improved.

Alternatively, the light valve can be a MEMS powered mechanism or Fabry-Perot interferometer like implementation. Such implementations do not require a polarizer.

FIG. 2B shows a side view of the see through display 2 when the light transflectors 214 are within the light transmitting substrate 212, and how the light may travel within the see through display 2. In a first example, light from a light source 210 may be coupled into light transmitting substrate 212 and the plurality of light transflectors 214. Light is reflected after passing through the light transmitting substrate 212 (through a first refractive index) and the plurality of light transflectors 214 (through a second refractive index). In this regard, the plurality of light transflectors 214 are angled away from the light source 210; i.e. the light travels interior to the plurality of light transflectors 214 and is reflected. In a second example, light from a light source 210 may be coupled into light transmitting substrate 212 and the plurality of light transflectors 214. Light is reflected after passing through the light transmitting substrate 212 (through a first refractive index) and before passing through the plurality of light transflectors 214. In this regard, the plurality of light transflectors 214 are angled towards the light source 210; i.e. the light travels exterior to the plurality of light transflectors 214 and is reflected.

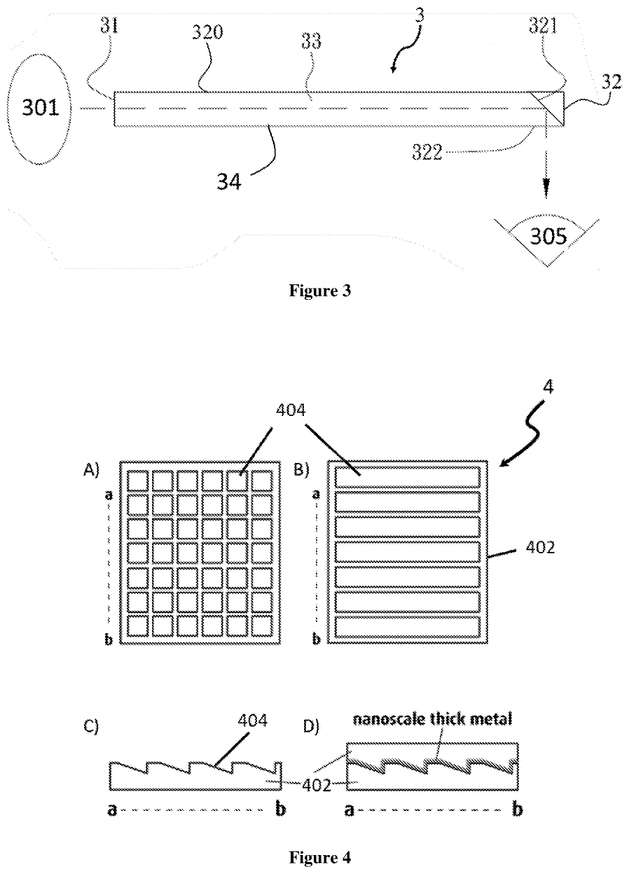

As mentioned, the light guiding apparatus comprises a light transmitting substrate 212 and a plurality of light transflectors 214. FIG. 3 shows a side view of an exemplary light guiding apparatus 3. The light guiding apparatus 3 is suitable for transmitting light (as indicated by a dashed arrow) from a light source 301 to a user's eye 305. The light guiding apparatus 3 comprises a light transmitting polymer guide 320 having a first edge 31, a second edge 32 extending from the first edge 31, and a light path 33 extending between the first edge 31 and the second edge 32. In this embodiment, the second edge 32 extends outward from the first edge 31; that is, the second edge 32 extends from the first edge 31, away from the light source 301. The light path 33 is disposed between the first edge 31 and the second edge 32. A surface 34 (facing the eye 305) lies between the first edge 31 and the second edge 32.

The light guiding apparatus 3 comprises at least one light transflector 321. For clarity, only one light transflector 321 is shown in FIG. 2. The light transflector 321 can be approximate to the second end 32, or can be anywhere within the light transmitting substrate. For example, FIG. 3 shows the light transflector 321 positioned at the second end 32. The light transflector 321 is disposed within the light transmitting substrate. For example, the light transflector can be fully embedded within the light transmitting substrate. Preferably, the light transflector is interposed within the light transmitting substrate. To this end, the light transflector is inserted or placed between two sections of the light transmitting substrate. The light transflector 321 is disposed at an angle relative to the light path 33 or to the surface. In this way, the light transflector 321 reflects the light towards a pre-determined direction towards a user 305. The second end 32 can be further surface treated by a coating 322 to form a light-leaving surface, but not limited to this.

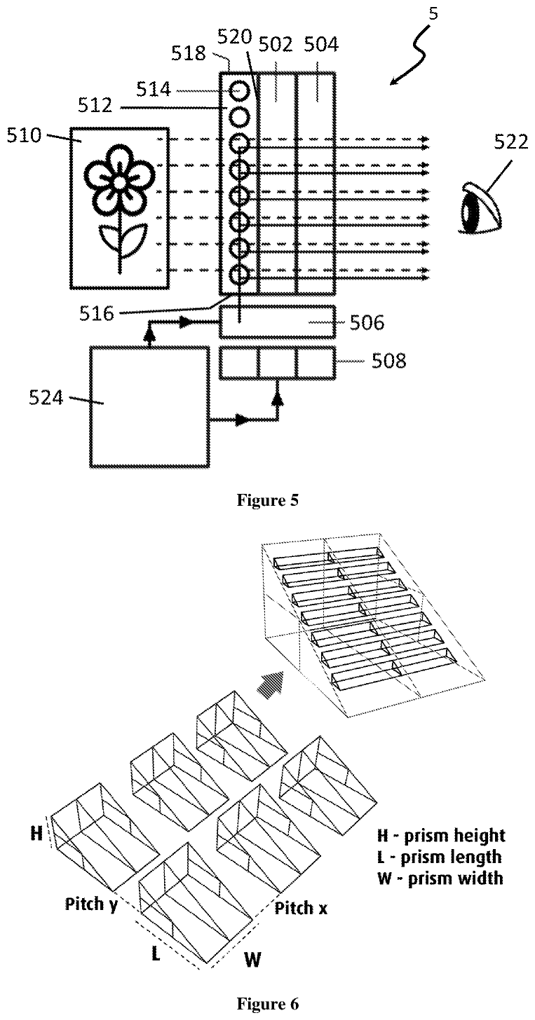

FIG. 5 shows schematic drawing of the see-through display. The see-though screen is formed from a light guiding apparatus, a light valve 502 and a first polariser 504. The light valve 502 is sandwiched between the light guiding apparatus and the first polariser 504. The light guiding apparatus comprises a light transmitting substrate 512 and a plurality of light transflectors 514. The light transmitting substrate has a first edge 516 and a second edge 518, a surface 520 between the first and second edges. Light is provided by a light source 508 adjacent to the first edge 516. The light from the light source 508 is directed along a light path into the light guiding apparatus and hence the light source 508 is optically connected with the light guiding apparatus. As the transmitted light is reflected by the light transflectors 514, the light is redirected through the light valve 502 and the first polariser 504 to form an image which can be viewed by a viewer 522. As the screen is see-through, the viewer 522 sees the real (image forming by the light spot illuminating on surface 502) or virtual (image forming by the focal free characterised light beam coupled-out from 504 to reach to 522 user's retina as the focal plane) image overlapping with the real image/object provided by the background 510. The see-through display can also comprise a second polariser 506 positioned between the light source 508 and the first edge 516. The see-through display can also comprise control electronic means 524 for controlling the light source 508, the light source and the light valve 502 work together to achieve synchronous operation. The control electronic means 524 is in electrical communication with the light source 508 and the light valve 502. Optionally the second polariser 506 and the first polariser 504 acts together with the light valve 502 to form an image. In this way, the colour of the light source can be modulated and the image can be defined by the light valve 502.

For example, a liquid crystal layer or equivalent light valves (for example, built on top of interferometer driven by MEMS) with pixel size same as or slightly bigger or smaller than the size of transflector pixel (or an integer multiplier) can be integrated on top of the light transmitting substrate as shown in FIG. 5. The reflected light with turning direction coupled out from the linear light source 508 guided into the light guiding apparatus, working through a sequentially scanning line-by-line or matrix addressing method to form the field-based image by using the light valve 502 switch control mechanism. Given that the desired color of any given pixel has been generated respectively at the light source, the light valve or LCD sub-pixels with RGB or CMY or any other colour filters for the colour production is not required to form the LCD pixels. With the removal of color filter(s) from the lamination of the display stack, more brightness and higher transparency can be achieved by the present invention. A first polarizer 504 with a specifically designed layout (the polarization applies only to the active area of light transmission switching) is placed in front of the light valve 502 optionally at right angle with the second polarizer 506 or a custom angle based the light valve 502. The display will be transparent normally. When an image is displayed on liquid crystal display (LCD), the polarised light emitted from the second polariser 506 is reflected from the light transflectors will be blocked by the first polariser 504 due the rotation of polarisation by ON pixels of the LCD. However, the light from the background object is unpolarized and will pass through the first polarizer 504. In this see-through display, with one polarizer in the viewer side, transparent light guiding apparatus, transparent light transflectors, transparent LCD and illumination from below with the second polarizer 506 make the entire display being transparent (see-through effect). At least 50% for white light and more than 80% for polariser light sources (such as lasers) are being guided until the display surface, which gives very high efficiency compared to two polarizer together placed on the display (˜5%) light efficiency.

By disposing the light transflector within the light transmitting substrate, or preferably interposed within the light transmitting substrate, leakage of the transmitted light within the light transmitting substrate is minimised. Further, extension of the light transmitting substrate rearward from the light transflector, such that the light transmitting substrate is in contact with an anterior surface and posterior surface of the light transflector, acts to direct stray light from interfering with the image received at the viewer's eye.

Referring to FIGS. 4A and 4B, the light transmitting substrate comprises a surface (front facing) and four edges. A plurality of light transflectors 404 are disposed on the surface of the light transmitting substrate 402 (FIG. 4C). Alternatively, the light transflectors 404 can be disposed within the light transmitting substrate 402 (FIG. 4D). At least one light source is positioned adjacent to an edge of the light transmitting substrate, for example at the edge indicated by b.

In some embodiments, when in use, each light transflector is configured to reflect a portion of the light away from the second edge. In some embodiments, when in use, each light transflector is configured to reflect a portion of the light in a direction away from the planar surface. To allow for viewing at a wide angle, the reflected light from the plurality of light transflectors can be varied such that a range is obtained. Alternatively, the light can be reflected in a direction substantially perpendicular to the surface. This allows a user positioned directly in front of the display to observe the image.

The light transflectors also optionally transmit the other portion of the light. Referring to FIGS. 4A and B, in which light from the light source travels from position b to position a, the first row of light transflector(s) at position b reflects a portion of light and transmits the other portion of light. The transmitting light from the first row of light transflector(s) at position b can arrive at the second row of light transflector(s), where a portion of the transmitted light is reflected and another portion of the light is transmitted to the third row of light transflector(s). This process is continued until the last row or iteration of light transflector(s), where the light can be partitioned into a reflected and transmitted light, or where the light is substantially reflected. For example, the last row of light transflector(s) can be configured to reflect light via total internal reflection. The light valve can further modulate the amount of reflected light that passes through the light valve. Alternatively, along the direction of the incident light from b to a, the height of the transflectors and/or microstructures on the transflectors can be gradually reduced or increased so that transmitted light received at a posterior transflector is not affected by an anterior transflector. By using the above two methods together or separately, the uniformity of brightness can be increased.

Further, the reflectivity of light reflectors at each row are adjusted either in an increasing order from b to a or decreasing order or a combination depending upon the type of reflectors and the location of light source. This ensures a uniform light distribution or even brightness.

The light transflector 321 is positioned at an angle relative to the light path 33 or the surface. This allows the light to be reflected out of the light path 33 towards a user 5. Preferentially, the light transflector is positioned or disposed such that it is not parallel to the light path, or not parallel to a longitudinal dimension or curvature of the light path. The light transflector is also positioned or disposed such that it is not perpendicular to the light path, or not perpendicular to a longitudinal dimension or curvature of the light path. For example, the light transflector can each be independently disposed at an angle of about 5° to about 80° relative to the light path or the surface. Preferably, the angle of about 5° to about 60° relative to the light path or the surface.

The tilting angle or area size of the light transflectors, and the pitch between the light transflectors along the light path may vary according to the angle of the incident light and the diameter of the incident light beam. Relatively larger light transflectors can give higher brightness, and the relatively larger pitch can create higher transparency. The transflectors may also be angled such that the reflected light from all the transflectors is focused at a focal point.

Surface microstructures can be additionally applied on any given light transflectors (close-up illustration shown in FIG. 6) to further control the reflection direction and behaviour of capturing the reached light. In addition, the top reflective surface or bottom gap (pitch of the spacing) between the microstructures can also be treated with different nanoscale thick metal coatings to manage the reflection respectively.

Given that the surface treatment over the light transflector surface is to reflect part of the reached light beam, as long as the critical angle limit of the total internal reflection of the incident light angle is controlled, another layer of transparent material can be added (by pouring or by laminating) above the nano-thickness metal coating to cover, which helps the metal coating process less required to take adhesion and fix into a consideration, which can increase the flexibility of material (for example, silicone oil based) and fabrication process selection. It has been verified that when a 50-micron thick optically clear adhesive glue is attached to the 30-micron height microstructure under pressure, the gap within microstructures can be perfectly filled up with no air left and the structural integrity can still be maintained without collapse to guarantee the optical performance as designed.

In some embodiments, the light at each of the plurality of light transflectors is subjected to one reflection. This means that the reflection of the light is not random but is purposefully directed towards a user. This may be controlled, for example, by the individual tilt of the transflectors. This reduces excessive loss of light at the interface through scattering.

Each transreflector can reflect the light of all colours in the visible and near infra red wavelengths.

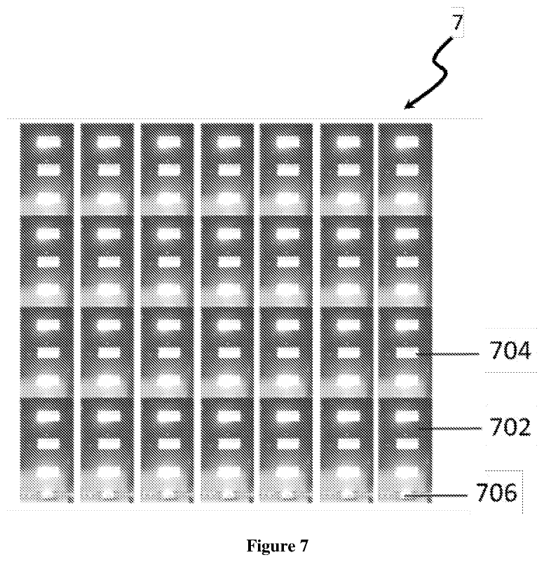

FIG. 7 shows experimentally created light transflectors in the light transmitting substrate. Here, polydimethylsiloxane (PDMS) is used as the light transmitting substrate. However, this material can be any polymer material (such as UV glue engraving on top of PC or PET based substrate) or transparent plastics or glass.

In some embodiments, the plurality of light transflectors is a one dimensional, two dimensional or three dimensional array of light transflectors. As used herein, “array” refers to an arrangement of at least two entities.

In some embodiments, when in use, each light transflector is dimensioned to correspond to a pixel in a formable image. This is exemplified in FIG. 4A. In some embodiments, each light transflector extends between a third edge and a fourth edge, the third and fourth edges transverse to the first edge. This is exemplified in FIG. 4B. In this regard, each light transflector corresponds to several pixels. When the light source is a laser, highly localised and focused light can be provided to distinct locations on the light transflector such that there is no mixing of the light. In this way, the light transflector is able to correspond to several pixels. Since lasers are polarised light beams, a polariser placed on the couple-in side is not required in the see through display. This further improves light efficiency and the transparency of the display.

The light transflector can have a homogenous surface. For the light transflector to sufficiently be able to reflect light, the boundary of the light transflector can be of a certain thickness. For example, the light transflector can have a thickness of about 3 nm to about 800 μm. In other embodiments, the light transflector has a thickness of about 3 nm to about 700 μm, about 3 nm to about 600 μm, about 3 nm to about 500 μm, about 3 nm to about 400 μm, about 3 nm to about 300 μm, about 3 nm to about 200 μm, about 3 nm to about 100 μm, about 3 nm to about 50 μm, about 3 nm to about 10 μm, about 3 nm to about 1 μm, about 3 nm to about 800 nm, about 3 nm to about 600 nm, about 3 nm to about 500 nm, or about 3 nm to about 250 nm.

The micron sized light transflectors can have any shape. For example, the light transflectors can have a shape such as a polygon, a cube, a linear grating like pattern, square, rectangular, hexagonal, prism or wedge shapes. In some embodiments, each light transflector is a triangular prism. In some embodiments, each light transflector is a right angled triangular prism. Depending on the setup, the hypotenuse can be facing the first edge or the second edge. For example, as shown in FIG. 3, when the light transflector on the surface and is a triangular prism with the hypotenuse facing the first edge, light travels from air and is reflected as it hits the polymer boundary.

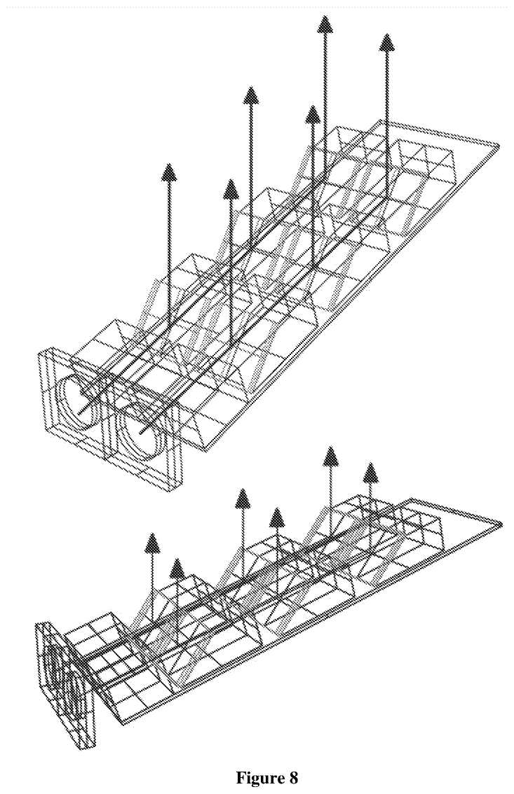

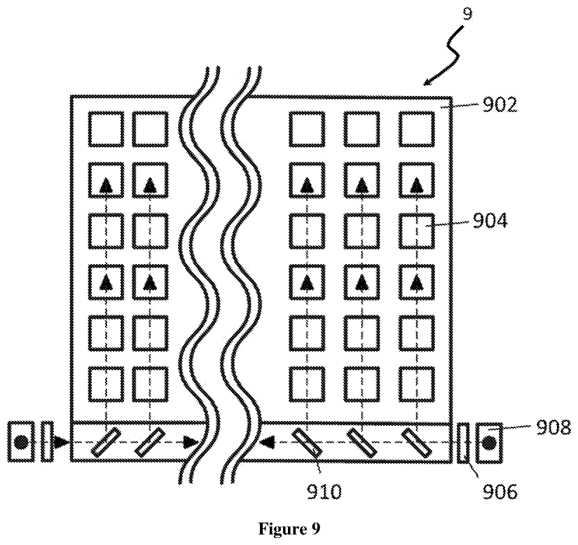

FIG. 8 shows how light is reflected from the light transflectors. In this example, the light transflectors are prism shaped.

In some embodiments, the light transflectors are regularly spaced apart. The spacing between the light transflectors can be dimensioned to allow sufficient light to pass through the light guiding apparatus in a perpendicularly to the surface such that it is transparent. In this regard, the light transflectors can be separated from each other by a spacing in one or two directions along the x and/or y axis in a Cartesian coordinate system.

In some embodiments, the light transflectors are separated by a pitch of about 0 mm to about 5 mm. In other embodiments, the light transflectors are separated by a pitch of about 0.2 mm to about 5 mm, about 0.4 mm to about 5 mm, about 0.5 mm to about 5 mm, about 0.6 mm to about 5 mm, about 0.8 mm to about 5 mm, about 1 mm to about 5 mm, about 1.2 mm to about 5 mm, about 1.4 mm to about 5 mm, about 1.6 mm to about 5 mm, about 1.8 mm to about 5 mm, about 2 mm to about 5 mm, about 2.2 mm to about 5 mm, about 2.4 mm to about 5 mm, about 2.6 mm to about 5 mm, about 2.8 mm to about 5 mm, about 3 mm to about 5 mm, about 3.2 mm to about 5 mm, about 3.4 mm to about 5 mm, about 3.6 mm to about 5 mm, about 3.8 mm to about 5 mm, about 4 mm to about 5 mm, about 4.2 mm to about 5 mm, about 4.4 mm to about 5 mm, or about 4.6 mm to about 5 mm.

In some embodiments, the light transflectors are separated by a pitch in a longitudinal direction of about 0 mm to about 5 mm. In other embodiments, the light transflectors are separated by a pitch of about 0.2 mm to about 5 mm, about 0.4 mm to about 5 mm, about 0.5 mm to about 5 mm, about 0.6 mm to about 5 mm, about 0.8 mm to about 5 mm, about 1 mm to about 5 mm, about 1.2 mm to about 5 mm, about 1.4 mm to about 5 mm, about 1.6 mm to about 5 mm, about 1.8 mm to about 5 mm, about 2 mm to about 5 mm, about 2.2 mm to about 5 mm, about 2.4 mm to about 5 mm, about 2.6 mm to about 5 mm, about 2.8 mm to about 5 mm, about 3 mm to about 5 mm, about 3.2 mm to about 5 mm, about 3.4 mm to about 5 mm, about 3.6 mm to about 5 mm, about 3.8 mm to about 5 mm, about 4 mm to about 5 mm, about 4.2 mm to about 5 mm, about 4.4 mm to about 5 mm, or about 4.6 mm to about 5 mm.

In some embodiments, the light transflectors are separated by a pitch in a transverse direction of about 0 mm to about 5 mm. In other embodiments, the light transflectors are separated by a pitch of about 0.2 mm to about 5 mm, about 0.4 mm to about 5 mm, about 0.5 mm to about 5 mm, about 0.6 mm to about 5 mm, about 0.8 mm to about 5 mm, about 1 mm to about 5 mm, about 1.2 mm to about 5 mm, about 1.4 mm to about 5 mm, about 1.6 mm to about 5 mm, about 1.8 mm to about 5 mm, about 2 mm to about 5 mm, about 2.2 mm to about 5 mm, about 2.4 mm to about 5 mm, about 2.6 mm to about 5 mm, about 2.8 mm to about 5 mm, about 3 mm to about 5 mm, about 3.2 mm to about 5 mm, about 3.4 mm to about 5 mm, about 3.6 mm to about 5 mm, about 3.8 mm to about 5 mm, about 4 mm to about 5 mm, about 4.2 mm to about 5 mm, about 4.4 mm to about 5 mm, or about 4.6 mm to about 5 mm.

In some embodiments, the light transflectors are separated by an edge to edge spacing of about 30 μm to about 300 μm. In other embodiments, the spacing is about 40 μm to about 300 μm, about 50 μm to about 300 μm, about 60 μm to about 300 μm, about 70 μm to about 300 μm, about 80 μm to about 300 μm, about 90 μm to about 300 μm, about 100 μm to about 300 μm, about 100 μm to about 280 μm, about 100 μm to about 260 μm, about 100 μm to about 240 μm, about 100 μm to about 220 μm, about 100 μm to about 200 μm, about 100 μm to about 180 μm, about 100 μm to about 160 μm, about 100 μm to about 140 μm, or about 100 μm to about 120 μm.

In some embodiments, each light transflector independently has a width of about 10 μm to about 10 mm.

In some embodiments, each light transflector independently has a length of about 1 μm to about 10 mm. In other embodiments, the length is about 10 μm to about 10 mm, about 20 μm to about 10 mm, about 30 μm to about 10 mm, about 40 μm to about 10 mm, about 50 μm to about 10 mm, about 60 μm to about 10 mm, about 70 μm to about 10 mm, about 80 μm to about 10 mm, about 90 μm to about 10 mm, or about 100 μm to about 10 mm. In other embodiments, the length is about 100 cm or more for large displays.

In some embodiments, each light transflector independently has a height of about 30 μm to about 300 μm. In other embodiments, the height is about 40 μm to about 300 μm, about 50 μm to about 300 μm, about 50 μm to about 280 μm, about 50 μm to about 260 μm, about 50 μm to about 240 μm, about 50 μm to about 220 μm, about 50 μm to about 200 μm, about 50 μm to about 180 μm, about 50 μm to about 160 μm, about 50 μm to about 150 μm, about 50 μm to about 140 μm, about 50 μm to about 120 μm, about 50 μm to about 100 μm, about 50 μm to about 90 μm, about 50 μm to about 80 μm, or about 50 μm to about 70 μm.

The length and width of each reflecting pixel can be optimised to increase the light reflection efficiency while remain optically invisible to the user. For example, with air filled light transflectors each representing pixels, the length will be kept the same as the size of one row of micro-display pixels and the width will be varied to cover 5 pixels to 25 pixels. If the micro-display has M rows and N columns, display size of 4 mm×4 mm is achievable with each display pixel size being 10 μm. Then the length of the air filled pixel will be designed to be 4 mm and will have a width of 50 μm (the air filled pixels cover 5 micro-display pixels in column and M pixels rows (4 mm)) or 1 mm (the air filled pixels cover 100 display pixels in column and M in rows (4 mm)).

A material or air having a lower refractive index than the light transmitting substrate can be used as a light transflector. This is based on the understanding of Snell's law that light in an optically denser medium can be reflected off an interface with a optically less dense medium if the angle at which the light makes with the normal of the interface is not 0, and preferably less than the critical angle. The critical angle is the angle of incident in an optically denser medium for which the angle of refraction is 90°.

When the light transflector is disposed on the surface of the light transmitting substrate, the light transflectors can comprise a polymer body. The polymer can be a light transmitting polymer. Light from the light source travels through air (or gas or vacuum) to strike at the angled surface of the light transflector to be reflected. Reflection is the change in direction of a wavefront at an interface between two different media so that the wavefront returns into the medium from which it originated. In this context, light is reflected as it travels from an air medium to a polymer medium. Alternatively, when the light transflector is disposed within the light transmitting substrate, the light transflector can be an air or gas filled body surrounded by the polymer or glass of the light transmitting substrate. In this regard, light is reflected as it pass from a polymer or glass medium to an air medium. The gas can be an inert gas such as argon or nitrogen.

FIG. 6 shows an example of a light guiding apparatus in which the light transflectors are embedded within the light transmitting substrate and the light transflectors are air filled. The light transflectors can be characterised by a height, length and width. As shown, the light transflectors can be prism shaped, preferably right angled prism shaped.

The air-polymer interface at the light transflectors can be coated to improve the reflection and/or transmittance property. For example, the light transflector can be coated with a metal or a material having a lower refractive index than the polymer. The coating modifies the boundary at which light is reflected.

When the light transflectors are coated, the light is reflected as it passes from an air medium to a coated surface medium, or from a polymer or glass medium to a coated surface medium. In some embodiments, each light transflector independently comprises a boundary selected from a metal-polymer boundary, an air-polymer boundary, an air-metal boundary, a material-polymer boundary, or a combination thereof, the material having a lower refractive index than the polymer. The material can be a light transmitting material.

The light transflector can be coated with a nanoscale metallic film, metal dielectric film or dielectric mirror. The material having a lower refractive index than the light transflector or light transmitting substrate can be polytetrafluoroethylene (PTFE). The material can have a refractive index of less than about 1.4. In some embodiments, the material is a dielectric material or a dielectric mirror (a dielectric stack). Dielectric coatings, also called thin-film coatings or interference coatings, consist of thin (typically sub-micron) layers of transparent dielectric materials. A dielectric mirror, also known as a Bragg mirror, is a type of mirror composed of multiple thin layers of dielectric material. Some dielectric materials, but are not limited to, are magnesium fluoride, silicon dioxide, tantalum pentoxide, zinc sulfide, and titanium dioxide.

A layer of metal such as aluminium or silver is a good transflector for light the visible spectrum. The reflectance of a metal layer can be calculated from the index of refraction n and the extinction coefficient k of the metal. The reflectance (R) of a metal surface in air is given by:

$$R ( \% ) = \frac{{( n - 1 )}^{2} + {k}^{2}}{{( n + 1 )}^{2} + {k}^{2}} \times 100.$$

In some embodiments, the metal is selected from gold, silver, aluminium, chromium, copper, nickel, platinum or their combination thereof.

The light transflectors can comprise a single layer coating or a multilayered coating. The coating can be a homogenous coating. Each coating layer can be about 1 nm to about 200 μm, about 1 nm to about 100 μm, about 1 nm to about 50 μm, about 1 nm to about 10 μm, about 1 nm to about 1 μm, about 1 nm to about 800 nm, about 1 nm to about 500 nm, or about 1 nm to about 100 nm thick. The multilayered coating can be about 5 layers to about 20 layers, or about 10 layers to about 20 layers. By layering the light transflectors with multiple layers (and also possibly with different metals or materials), a greater percentage of light is reflection and/or transmitted without being lost as scattered light. Depending on the thickness of the material, the amount of light that is reflected can be varied, and at the same time the transparency of the image guiding apparatus can be varied.

The coating can be applied only on the light transflectors. In other words, the spacing between the light transflectors is uncoated (to create reflection) while the transflectors are coated (to enable anti-reflection). This further improves the transparency of the light guiding apparatus as there is less scattering of transmitted light.

The light transflectors can each further comprise an array of nanostructures and/or microstructures at the boundary. The array of nanostructures and/or microstructures allows light to be selectively reflected to a viewer's eye and at the same time allows for transparency. For example, the coating as mentioned above can be formed as an inhomogeneous coating, or a patterned coating with nanostructures and/or microstructures.

When the light transflectors comprises of nanostructures and/or microstructures (pixilation), the reflectance (R) of a metal surface in air is given by:

$$R ( \% ) = \frac{{( n - 1 )}^{2} + {k}^{2}}{{( n + 1 )}^{2} + {k}^{2}} \times {f}_{pitch} \times {f}_{structure size} \times {f}_{structure thickness} \times 100$$

wherein ‘f’ denotes ‘function of’.

Similarly for air-filled pixels, the reflectance (T) is given by

$$T ( \% ) = {f}_{s} \times {f}_{pitch} \times {f}_{structure size} \times {f}_{structure thickness} \times 100$$

Wherein fₛ is a function of the total internal reflection.

It was found that this feature allows for transparency of the light transflector, which allows the light guiding apparatus to be used in augmented reality. In this sense, an image can be reflected to a viewer's eye through reflection at the nanostructures and/or microstructures. The pitch or spacing within the array of structures allows light transmitting (through the surface) from the real world physical object to pass through, thus providing visibility. The viewer can thus see an overlap of the image and the physical object even when the light guiding apparatus is positioned in front of the viewer's eye. Depending on the application, the nanostructures and/or microstructures can be configured to either focus the reflected light towards the user, thus provides for a brighter and clearer image, or to provide a wider viewing angle. This is particularly advantageous for applications in headgear, as it accommodates for different head sizes and a perceived depth of field by the viewer.

For example, when the light transflector is positioned at an angle relative to the light path or surface, each of the nanostructures and/or microstructures can be independently positioned at an angle relative to the light transflector. In this sense, each of the nanostructures and/or microstructures is positioned at various angles relative to the light path. For example, when the light transflector is positioned at 45° relative to the light path or surface, each of the nanostructures and/or microstructures can be independently positioned at an angle of 0° to about 40° offset from the plane of the light transflector. Accordingly, each nanostructures and/or microstructures can independently be about 5° to about 85° relative to the light path or surface. Preferably, the angle is of about 5° to about 80°, or about 15° to about 60° relative to the light path.

Further, as the array of nanostructures and microstructures allows for multiple reflections at various angles, by tuning the angles of these structures, an image at a light source can be expanded to an appropriate size for viewing by a viewer. This allows for miniaturization of other components that are used together with the light guiding apparatus. The expansion of an image from a source to the eye can be dependent on reflection angle, width and thickness (depth) of the nanostructures and/or microstructures.

In some embodiments, an expansion ratio (of the image at a light source to the image at an eye) is about 2 to about 100. In other embodiments, the expansion ratio is about 5 to about 100, about 10 to about 100, about 15 to about 100, about 20 to about 100, about 25 to about 100, about 30 to about 100, about 35 to about 100, about 40 to about 100, about 45 to about 100, about 50 to about 100, about 55 to about 100, or about 60 to about 100.

In some embodiments, each of the nanostructures and/or microstructures is formed from a metal selected from gold, silver, aluminium, chromium, copper, nickel, platinum or their combination thereof.

In some embodiments, each of the nanostructures and/or microstructures is disposed at an angle of about 5° to about 800 relative to surface.

Additionally, the thickness, width and size of the nanostructures and/or microstructures can be varied to tune reflectivity and the light transmitted through from outside to enable see through.

In some embodiments, each of the nanostructures and/or microstructures independently has a thickness of about 4 nm to about 500 μm, about 4 nm to about 400 μm, about 4 nm to about 300 μm, about 4 nm to about 200 μm, about 4 nm to about 100 μm, about 4 nm to about 50 μm, about 4 nm to about 10 μm, about 4 nm to about 5 μm, about 4 nm to about 1 μm, about 4 nm to about 800 nm, about 4 nm to about 600 nm, about 4 nm to about 500 nm, about 4 nm to about 400 nm, about 4 nm to about 200 nm, about 4 nm to about 100 nm, or about 4 nm to about 60 nm. Depending on the thickness of the metal layer, the amount of light that is reflected can be varied, and at the same time the transparency of the image guiding apparatus can be varied.

In some embodiments, each of the nanostructures and/or microstructures independently has a width of about 1 μm to about 1000 μm. The nanostructures and/or microstructures can each independently have a size or width of about 10 μm to about 1000 μm, about 20 μm to about 1000 μm, about 30 μm to about 1000 μm, about 40 μm to about 1000 μm, about 50 μm to about 1000 μm, about 50 μm to about 800 μm, about 50 nm to about 700 μm, about 50 nm to about 500 μm, about 50 nm to about 300 μm, about 50 nm to about 100 μm, about 50 nm to about 70 μm, about 50 nm to about 50 μm, or about 50 nm to about 10 μm. For example, nanostructures and/or microstructures can made of gold and have a size of about 50 μm.

In some embodiments, each of the nanostructures and/or microstructures independently has a pitch of about 1 μm to about 1000 μm. The pitch between the nanostructures and/or microstructures can each independently be about 10 μm to about 1000 μm, about 20 μm to about 1000 μm, about 30 μm to about 1000 μm, about 40 μm to about 1000 μm, about 50 μm to about 1000 μm, about 50 μm to about 800 μm, about 50 μm to about 600 μm, about 50 μm to about 500 μm, about 50 nm to about 400 μm, about 50 nm to about 300 μm, about 50 nm to about 200 μm, about 50 nm to about 100 μm, about 50 nm to about 70 μm, about 50 nm to about 50 μm, or about 50 nm to about 10 μm. For example, pitch can be about 20 μm.

For example, the length and width of the nanostructures and/or microstructures will be varied to cover 5 pixels to 25 pixels. For example, if the micro-display has M rows and N columns, a display size of 4 mm*4 mm and each pixel size of 10 μM in length and width. Then the length and width of each reflecting pixels will be of 50 μm*50 μM (each pixel covers 5 micro-display pixels in column and 5 pixels in rows) or 250 μM*250 μM (covers 25 pixels in column and 25 pixels in row).

The nanostructures and/or microstructures can have each independently have a different shape. For example, the shape can be square, rectangle, triangle, circular, hexagonal or polygonal. The above array of nanostructures and/or microstructures can be arranged in different configurations. For example, the array can be a square array, hexagonal array, triangular array, rectangular array. The boundaries of the array can be undefined or not straight such that a random array is arranged.

The light transmitting substrate transmit the light from the first edge towards the second edge. In some embodiments, the surface is a planar surface. In other embodiments, the surface is a curved surface. This gives a light guiding apparatus which is curved or planar. To this end, the light transmitting substrate can be of a curved configuration. When the light transmitting substrate is curved, there is no line of sight along the light path between the first end and the second end. In some embodiments, the light transmitting substrate is flexible. This allows the light transmitting substrate to be stacked against a curved light valve. By being able to bend the light via the light guiding apparatus, the installation flexibility in a space-limited apparatus can be improved.

Stiffness (or rigidity) is a property of a polymers that can be described by flexural modulus or bending modulus of elasticity. Flexural modulus denotes the ability of a material to bend. It is a measure of a materials stiffness/resistance to bend when a force is applied perpendicular to the long edge of a sample—known as the three point bend test. The flexural modulus is represented by the slope of the initial straight line portion of the stress-strain curve and is calculated by dividing the change in stress by the corresponding change in strain. Hence, the ratio of stress to strain is a measure of the flexural modulus. Flexural Modulus can be measured by test methods such as ASTM D790 and ISO 178. Flexural or bending modulus of elasticity can be equivalent to the tensile modulus (Young's modulus) or compressive modulus of elasticity.

The light transmitting substrate can have a flexural modulus of less than about 4 GPa, or less than about 2 GPa. This provides the light guiding apparatus with an acceptable flexibility for conforming to a morphology of a surface. For example, the surface can have a curved morphology. To this end, the light guiding apparatus can be flexible to conform to the curved morphology of the surface, or the light guiding apparatus can be curved (molded in a mold) which can be positioned in close contact with the surface having a curved morphology.

The flexibility of the light transmitting substrate can be characterised by a stiffness value and/or a hardness value. The stiffness can be a bending stiffness. For example, when polydimethylsiloxane (PDMS) is used, the stiffness can be from about 0.5 MPa to about 8 MPa.

In some embodiments, the light transmitting substrate comprises a light transmitting polymer or glass. In some embodiments, the light transmitting polymer is selected from polydimethylsiloxane (PDMS), polycarbonate, polyester, acrylic such as poly(methyl methacrylate), polyethylene terephthalate (PET), polyimide (PI), polyethersulfone (PES), their derivatives and combinations thereof.

To further improve the transmission of light at the light transmitting substrate, total internal reflection can be utilised. Without wanting to be bound by theory, based on Snell's law and total internal reflection (n_{PDMS} sin (Qc)=nₐᵢᵣ sin (90)), when the light enters the light transmitting substrate (PDMS refractive index=1.43) from the first edge to light transflector (air-filled structure), the transmitted light can be configured to contact the boundary at the surface at greater than the critical angle. This prevents or at least reduces the loss of light.

The light transmitting substrate is capable of transmitting light. The transmittance of a material is the proportion of the incident light that moves all the way through to the other side; i.e. the effectiveness in transmitting light. The light transmitting substrate is light transmitting in that it is capable of transmitting at least 90% of light from the light source, or at least 85%, at least 80%, at least 75%, at least 70%, at least 65% or at least 60%.

Alternatively, the light transmitting substrate can have a transparency of more than about 90%. Transparency (or transmission of visible light) is characterized by light transmittance, i.e. the measured percentage of incident light transmitted through a material. The higher the transmittance, the higher the transparency. In other embodiments, the transparency is more than about 85%, about 80%, about 75%, about 70%, about 65% or about 60%.

The light transmitting substrate is capable of transmitting light in the visible light spectrum; i.e. wavelength of about 380 nm to 740 nm. To this end, the light transmitting substrate 320 is capable of transmitting at least the primary colours (red, yellow, blue). The light transmitting substrate 320 can be capable of transmitting monochromatic light (red, orange, yellow, green, cyan, blue, violet). The light transmitting substrate can be also capable of transmitting mixed colours, for example, pink and magenta.

The light transmitting substrate can have a refractive index of about 1.4 to about 1.6. For example, if PDMS is used to form the polymer guide, the polymer guide can have a refractive index of about 1.4.

The refractive index (n) of a material is a dimensionless number that describes how fast light travels through the material. It is defined as

$$n = \frac{c}{v}$$

where c is the speed of light in vacuum and v is the phase velocity of light in the medium. The refractive index determines how much the path of light is bent, or refracted, when entering a material.

In some embodiments, the light transmitting substrate has a cross sectional thickness of about 1 μm to about 10 mm. In other embodiments, the thickness is about 1 μm to about 8 mm, about 1 μm to about 6 mm, about 1 μm to about 4 mm, about 1 μm to about 2 mm, about 1 μm to about 1 mm, about 1 μm to about 900 μm, about 1 μm to about 800 μm, about 1 μm to about 700 μm, about 1 μm to about 600 μm, about 1 μm to about 500 μm, about 1 μm to about 400 μm, about 1 μm to about 300 μm, about 1 μm to about 200 μm, or about 1 μm to about 100 μm.

In some embodiments, the light transmitting substrate is characterised by a light transmittance transverse to the surface of at least about 85%, about 86%, about 87%, about 88%, about 89%, about 90%, about 91%, about 92%, about 93%, about 94%, about 95%, about 96%, about 97%, about 98%, or about 99%.

A groove or a curved surface (concave or convex) can be further formed in the light guiding apparatus. In other embodiments, a plurality of grooves can be formed in the light path of the light guiding apparatus and can be disposed in a parallel or in an array form. The groove can be in the light transmitting substrate or interspersed between the light transflectors on the surface of the light transmitting substrate. The grooves can be disposed close to both or either of the first edge and the second edge. Advantageously, the grooves can be used to alter light travelling in the light path as it refract or reflects through different optical structures. The shape, size of the image formed by the light can thus be adjusted and which functions to modify the image achieved by the user.

In some embodiments, the light guiding apparatus is characterised by an absence of a cladding layer on its surface. The cladding layer can be absent on the surface adjacent to the light valve.

In some embodiments, the light guiding apparatus is bordered by a cladding layer along it edges. The cladding layer can comprise one or more layers of materials of lower refractive index than the light transmitting substrate. The cladding layer along the edges prevents a loss of light which can improve efficiency. The cladding layer can be advantageous as it allows light to be confined to the light transmitting substrate by total internal reflection (instead of just internal reflection) at the boundary between the two. To this end, light propagation in the cladding layer is suppressed and light leakage can be eliminated or at least reduced.

The cladding layer can be selected from a metal, a material having a lower refractive index than the polymer guide, or a combination thereof. When the cladding layer is a metal, the metal can be selected from gold, silver, aluminium, chromium, copper, nickel, or platinum. When the cladding layer is a material having a lower refractive index than the polymer guide, the material can be selected from air, or polytetrafluoroethylene (PTFE). In some embodiments, the cladding layer comprises a dielectric material or a dielectric mirror (a dielectric stack). A dielectric mirror, also known as a Bragg mirror, is a type of mirror composed of multiple thin layers of dielectric material. Some dielectric materials, but are not limited to, are magnesium fluoride, silicon dioxide, tantalum pentoxide, zinc sulfide, and titanium dioxide.

The cladding layer can be about 50 nm to about 200 nm thick. Alternatively, it can be less than about 150 nm, about 120 nm, about 100 nm, about 80 nm, about 50 nm, about 40 nm, about 30 nm, about 20 nm or about 10 nm.

In some embodiments, the light guiding apparatus is characterised by an absence of a buffer layer on its surface. The buffer layer can be absent on the surface adjacent to the light valve.

In some embodiments, the light guiding apparatus is bordered by a buffer layer along it edges. A buffer layer can be used to envelope or encapsulate the light guiding apparatus for the purpose of providing mechanical isolation, protection from physical damage and ease of identification. The buffer layer may take the form of a miniature conduit, containing but not connected to the light guiding apparatus (loose buffer). Alternatively, the buffer layer can be in intimate contact with the light guiding apparatus (tight buffer).

The buffer layer can be applied to the light guiding apparatus by methods such as spraying, dipping, extrusion and electrostatic methods. Materials used to create buffers can include fluoropolymers such as polyvinylidene fluoride (Kynar), polytetrafluoroethylene (Teflon), silicon dioxide or polyurethane.

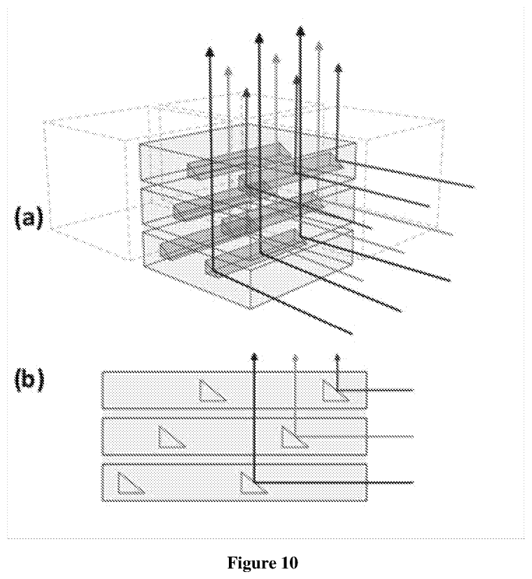

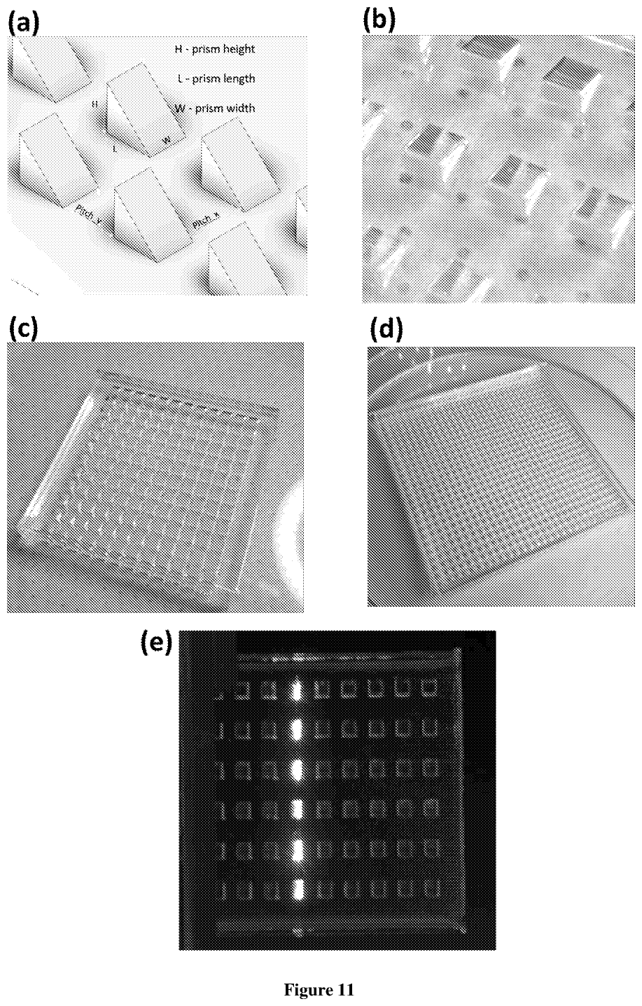

A multilayered light guiding apparatus is shown in FIG. 10. This can be obtained by stacking a plurality of light guiding apparatus on top of each other such that the light transflectors are displaced relative to the surface. This will enable colour image production where each transflector reflects composite color (in this case, one transflector forms a full pixel) or one colour in RGB (in this case, one transflector forms a subpixel), will make capturing the effective luminous flux increased, will enable making a few micron size pixels with closely spaced pitch and will enable to group a few number of transflectors across layers and hence to increase the pixel size, brightness of the light reflected from the coupling end to the far-end. The light source also can be a laser powered to maintain the characteristic of focal free to form imaging on viewer's retina for near-eye AR applications FIG. 11 shows some examples of the light guiding apparatus with the light transflectors.

The light transmitting substrate is formed from PDMS and the light transflectors have different sizes and pitches. Laser from a light source can be reflected off the light transflectors. By tuning the light valve, the reflected light from selective light transflectors can be observed, thus images can be formed.

The light guiding apparatus can further comprise a lens. The lens can be a single lens or an array or lenses. The lens can be positioned within the polymer guide, or between the first end of the polymer guide and the light transflector. In this way, the image from, for example, a micro-display can be coupled into the first end of the polymer guide (waveguide) using suitable coupling optics. The images in the waveguide can undergo multiple reflection. After each reflection, the image can increase in size or will remain same size depending on the magnification of the lens or lenses. The magnified image can thus be reflected out to the user.

In some embodiments, the at least one light guiding apparatus is contacted with a first surface of the light valve. This allows most if not all of the reflected light to pass through the light valve.

In some embodiments, the light valve is a reflective light valve or a transmissive light valve. In other embodiments, the light valve is a transmissive light valve. In a transmissive light valve, the source light is first polarised by a filter in one direction and then passed on to another filter, filled with liquid crystals. By changing the voltage applied to this crystal filter, it will work as a switching polarising filter, giving different grayscales of the light coming out. The light is changed only once for each image frame. The light valve thus consists of the two polarising filters and a voltage controlled switch function provided by the properties of the liquid crystals.

In reflective light valve, light is reflected towards or deflected away from the target. The portion of light that is reflected on the target decides the grayscale. This re- and deflection occurs many times a second. Should this happen at too low a frequency, the human eye and brain would perceive it as flickering, but due to sufficiently high frequency, a human will be “tricked” into viewing it as a continuum, a smooth shift in brightness.

In some embodiments, the light valve is a liquid crystal layer sandwiched between two electrode layers. In some embodiments, the electrode layer comprises indium tin oxide (ITO) and/or silicon on glass.

In some embodiments, the see-through display further comprises a first polarizer stacked adjacent to the light valve, the polarizer optically connected with the light valve. The polariser is used for getting light of a given polarization.

In some embodiments, the first polariser is contacted with a second surface of the light valve. The first polarizer optically connected with the light valve. The first polariser is optically connected with the light guiding apparatus via the surface. The second surface of the light valve is distal to the first surface of the light valve. The first surface of the light valve is adjacent to the surface of the light guiding apparatus.

The light source can be used to project a visible light to the light guiding apparatus. In some embodiment, the light source is an organic light-emitting diode display. In other embodiments, the light source is a light-emitting diode display, a micro light-emitting diode display, a MEMS controlled laser projector, a liquid crystal on silicon projector, a thin film transistor liquid crystal display, or a digital light processing projector. In some embodiments, the light source can be from a screen of a mobile phone. For example, the micro-display unit can be integrated with processors, electronics and rechargeable mini-batteries for feeding images. In some embodiments, the at least one light source is selected from a MEMS powered beam scanning engine, a linear array of lasers, LEDs, or a combination thereof.

For example, the light source can be a linear array of light sources (lasers or LEDs) (N numbers) placed (by printing light-emitting components on a strip shaped circuit board, or by one single light source working in conjunction with couple-in light guide component or by MEMS powered beam scanning engine). The light source creates the specific color from the beginning at pixel level by combination of colors from red, green and blue (RGB), white coloured or cyan, magenta and yellow (CMY). The size of the light source is smaller than a transflector (or greater than transflector and pitch in some cases). The pitch of the linear light source can be the same as the light transflector's pitch. When the linear light source is turned on using the control electronics, the light is guided through the light guiding apparatus and each light transflector then acts as an illuminated pixel with light partially reflecting towards a viewer.

The light source can be constantly ON or switched on in different patterns in synchronous with the light valve using the control electronics.

In some embodiments, the light source further comprises a brightness enhancement film (BEF), duel brightness enhancement film (DBEF), a light diffuser, or their combination thereof.

FIG. 9 shows a different arrangement illumination scheme where only two light sources are placed on the left and right of the first edge. Here, partially reflecting structures are additionally included to selectively direct light to the light guiding apparatus. This can also be implemented using one light source.

The visible light beam can have a wavelength ranging from about 380 nm to about 750 nm, which can be observed by human eyes.

Invisible light sources inserted between visible light sources at intervals can generate light beams with wavelength ranging from about 900 nm to about 1600 nm, which can not be observed by human eyes but used for interacting with the objects in front of the display by working with the other light capturing device to analyse the pattern formed by the captured reflected light.

In some embodiments, the see through display further comprises a light transmitting polymer guide between the at least one light source and the edge of the light transmitting substrate, the polymer guide optically connected with the light source and the light guiding apparatus.

In some embodiments, the see-through display further comprises a second polarizer between the at least one light source and the first edge of the light transmitting substrate, the polarizer optically connected with the light source and the light guiding apparatus.

Advantageously, positioning the second polariser away from the liquid crystal panel but still optically connected improves the transmission efficiency of the display.

In some embodiments, the first polariser and the second polariser are crossed polarised.

In some embodiments, the see-through display further comprises control electronic means for controlling the light source. In some embodiments, each light transflector is addressed by sequentially scanning the light transflectors line-by-line or by a matrix addressing method. In some embodiments, the matrix addressing method is a passive matrix method or an active matrix method.

In some embodiments, the see through display further comprises optical coupling means for coupling light from light source to the light guiding apparatus. This further improves the amount of light which is transmitted to the light guiding apparatus.

In some embodiments, the see-through display is characterised by an absence of colour filter adjacent to the light guiding apparatus.

In some embodiments, the see through display is characterised by a light transmittance of at least about 85%, about 80%, about 75%, about 70%, about 65% or about 60%. The light transmittance is transverse to the surface of the light transmitting substrate. In some embodiments, the see-through display is characterised by a light transmittance of at least 50% for white light. In other embodiments, the light transmittance is at least 55%, at least 60%, at least 65%, at least 70%, at least 75%, at least 80%, at least 85%, or at least 90%. In other embodiments, the light transmittance is more than 80% for polarised light. In other embodiments, the light transmittance is more than 85%, more than 90%, or more than 95%.

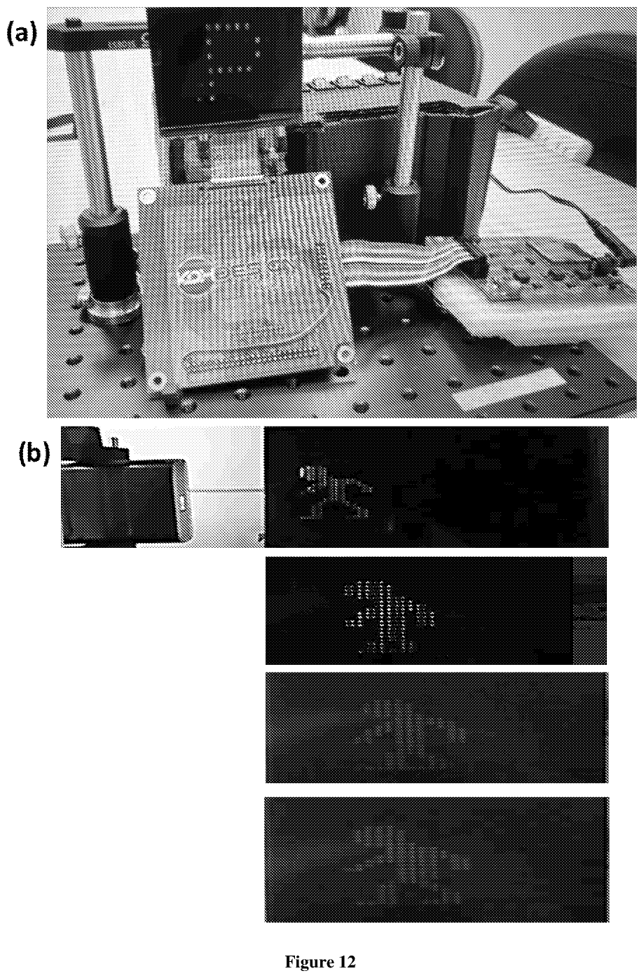

FIG. 12 shows a setup of the see-through display. The see-through display can be used with white and RGB colour light source, and the image can be animated though the functioning of the light valve.

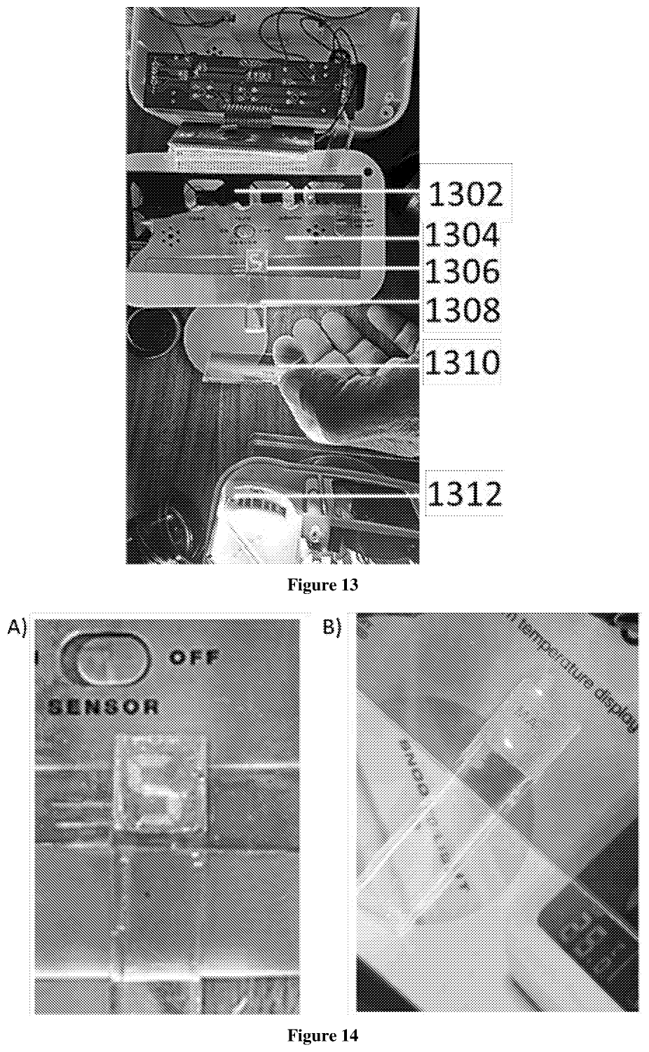

FIG. 13 shows the see-through display compared to other displays in a side by side comparison. A light source 1312 projects a light through a polariser 1310 and a light transmitting substrate 1308 of the light guiding apparatus. As the light is reflected by the light transflector 1306 and passes through a light valve and another polariser, an image can be formed. In comparison, a LCD layer with two polarisers 1302 is opaque. While a LCD layer with one polariser 1304 is transparent, its sole use cannot give an image without the reflected light.

FIG. 14 shows the light guiding apparatus in use with white light or laser light.

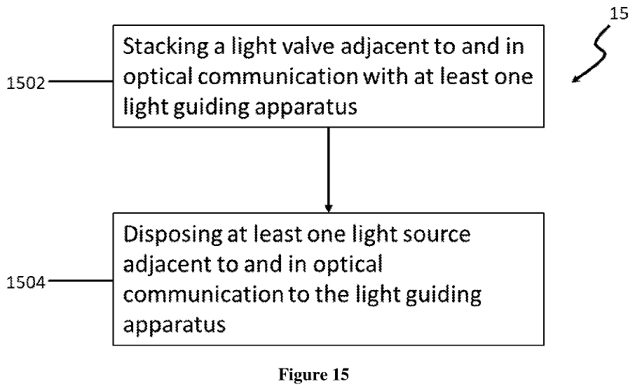

The present invention also relates to a method of fabricating the see-through display. FIG. 15 is a flow chart of a method of fabricating the see-through display. The method comprises a step 1202 of stacking a light valve adjacent to and optically connected with at least one light guiding apparatus, and a step 1504 of disposing at least one light source adjacent to and optically connected to the light guiding apparatus.

Accordingly, the present invention also relates to a method of fabricating a see-through display, comprising:
a) stacking a light valve on a surface of at least one light guiding apparatus such that the light valve is optically connected with the at least one light guiding apparatus, the at least one light guiding apparatus comprising:
   i) a light transmitting substrate comprising a first edge, a second edge and a surface between the edges; and
   ii) a plurality of light transflectors disposed on the surface or within the light transmitting substrate; and
b) disposing at least one light source adjacent to the first edge of the light transmitting substrate and optically connected with the at least one light guiding apparatus in order to transmit a light from the light source along a light path from the first edge towards the second edge;
   wherein when in use, each light transflector is configured to reflect a portion of the light away from the light path and to optionally transmit the other portion of the light along the light path.

The light guiding apparatus and at least the light valve can be jointly connected like a strip line as illustrated on the right-hand side of FIG. 2. The light transflectors can be made (a) by creating a smaller or higher refractive index volume of same or different shapes than the refractive index of the matrix using two photon polymerisation or equivalent laser writing inside a matrix, (b) air filled structures in matrix or multi-layered air filled structures, or (c) nanoscale thickness metal coated air-filled structures to tune the transmission/reflection or multilayered nanoscale thickness metal coated air-filled structures inside the matrix. The size of transflectors can vary from a few mm to micron/submicron range.

As an example, 3D printed mold with prism cut coupling side can be used as a starting material. The 3D printed mold has large surface roughness due to layer by layer printing, especially on the walls. A flexible smooth plastic film or a glass wafer or silicon wafer of suitable size (called insert layer) is used to cover the inner side of the 3D printed mold to make the surface walls smooth. PDMS is poured and cured to make the flexible polymer guide. The polymer guide is provided with 3 prism cuts, into which 5 to 20 nm metal (gold) is deposited on one side of the cut structures. The polymer guide with prism cuts are aligned and connected together using oxygen plasma such that the deposited gold structures are embedded within the polymer guide. The area not covered with gold will attach strongly due to PDMS-PDMS interactions. If a smooth mold is printed using advanced metal printers or any other techniques, the insert layer is not required.

For example, a gold film of around 20 nm to about 40 nm can be deposited using metal evaporation only on the waveguide part (on one face) leaving the air-filled display part and four edges (FE) of the PDMS layer using a metallic mask. This gold spacer film will prevent light leakage from the individual waveguide film while bending.

Here, the light will be coupled out using the nanothick metal layer into eyes and same time the nanoscale gold is transparent to see the outside world.

As another example, the method above can be used for forming light transflectors that consist of air. In this embodiment, instead of depositing gold, PDMS can be etched on one side of the cut prism structures such that trenches are formed. When the polymer guide with prism cuts are aligned and connected together using oxygen plasma, the air structures are embedded within the polymer guide.

For example, the air-filled light transflectors can be fabricated using Nanoscribe Photonic Professional GT2 (GT2). The 3D nanoscribe is a ‘high resolution printer’ that combines the technique of 2 photon polymerisation (2PP) with a traditional 3D printing workflow used for additive manufacturing. It offers a one-step process to fabricate almost any arbitrary complex 3D shapes and objects in 3D with nanoscale resolution over a large area. It is also possible to achieve steep slopes, sharp edges, smooth surfaces, and even complex 3D designs. The nanoscribe has a resolution close to −100 nm, over an area of 100×100 mm², maximum height of up to 10 mm and with writing speeds of up to 1 mm³ in 10 seconds. A single polymer master for the air-filled reflecting pixels and waveguide can be made with registration marks on corners for alignment (for example, a single film of 500 μm thick). The engineering of PDMS can be carried out to make refractive index uniform across the film, fast curing and for making surface smooth. The engineered PDMS can be poured for curing to get the single waveguide layer embedded with the reflecting pixels. The film will then be peeled off and kept on a clean silicon wafer. This step will be repeated to build multiple layers.

The light guiding apparatus can be connected to the light valve via optically clear adhesive glue. Alternatively, an optically clear polymer can be used, such as a very thin layer of PDMS film or PMMA.

Layer-by-layer stacking of the light guiding apparatus to the light valve and polariser using photonic alignment machine can be done to make the see-through display. The registration mark can be used for the alignment. When the individual layers are properly spaced, the machine will be able to pick and place one by one due to its automatic mode. The bonding between the layer can be done either using PDMS bonding on the four edges or using refractive index glue and glue table in the alignment machine.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A see-through display, comprising:
a) at least one light guiding apparatus, comprising:
i) a light transmitting substrate having a first edge, a second edge and a surface between the edges; and
ii) a plurality of light transflectors disposed on the surface or within the light transmitting substrate;
b) a light valve stacked on the surface of the light guiding apparatus and optically connected with the at least one light guiding apparatus; and
c) at least one light source adjacent to the first edge of the light transmitting substrate and optically connected with the at least one light guiding apparatus in order to transmit a light from the light source along a light path from the first edge towards the second edge,
wherein, when in use, each light transflector is configured to reflect a portion of the light away from the light path and to optionally transmit the other portion of the light along the light path.

2. The see-through display according to claim 1, wherein each light transflector is independently at an angle relative to the surface.

3. The see-through display according to claim 1, wherein each light transflector is independently at an angle of about 5° to about 80° relative to the surface.

4. The see-through display according to claim 1, wherein each light transflector independently comprises a boundary selected from a metal-polymer boundary, an air-polymer boundary, an air-metal boundary, a material-polymer boundary, or a combination thereof, the material having a lower refractive index than the polymer.

5. The see-through display according to claim 1, wherein the plurality of light transflectors is a one dimensional, two dimensional or three dimensional array of light transflectors.

6. The see-through display according to claim 1, wherein when in use, each light transflector is dimensioned to correspond to a pixel in a formable image.

7. The see-through display according to claim 1, wherein each light transflector extends between a third edge and a fourth edge, the third and fourth edges transverse to the first edge.

8. The see-through display according to claim 1, wherein each light transflector is a triangular prism.

9. The see-through display according to claim 1, wherein the light transflectors are separated by a pitch of about 0 mm to about 5 mm.

10. The see-through display according to claim 1, wherein the light transflectors are separated by an edge to edge spacing of about 30 μm to about 300 μm.

11. The see-through display according to claim 1, wherein one or more of:
each light transflector independently has a width of about 10 μm to about 10 mm;
each light transflector independently has a length of about 1 μm to about 10 mm; and
each light transflector independently has a height of about 30 μm to about 300 μm.

12.-13. (canceled)

14. The see-through display according to claim 1, wherein each light transflector comprises a gas, air or a light transmitting polymer.

15. The see-through display according to claim 4, wherein each air-metal boundary comprises a metal with a thickness of about 3 nm to about 800 μm, wherein the metal is selected from gold, silver, aluminium, chromium, copper, nickel, platinum or their combination thereof.

16. (canceled)

17. The see-through display according to claim 1, wherein each boundary independently comprises an array of nanostructures and/or microstructures and, optionally, one or more of:
each of the nanostructures and/or microstructures is disposed at an angle of about 5° to about 80° relative to planar surface;
each of the nanostructures and/or microstructures independently has a thickness of about 4 nm to about 500 μm;
each of the nanostructures and/or microstructures independently has a width of about 1 μm to about 1000 μm; and
each of the nanostructures and/or microstructures independently has a pitch of about 1 μm to about 1000 μm.

18.-21. (canceled)

22. The see-through display according claim 1, wherein the light transmitting substrate comprises a light transmitting polymer or glass and, optionally, the light transmitting polymer is selected from polydimethylsiloxane (PDMS), polycarbonate, polyester, acrylic such as poly(methyl methacrylate), polyethylene terephthalate (PET), polyimide (PI), polyethersulfone (PES), their derivatives and combinations thereof.

23. (canceled)

24. The see-through display according to claim 1, wherein one or more of:
the light transmitting substrate has a cross sectional thickness of about 1 μm to about 10 mm;
the light transmitting substrate has a flexural modulus of less than about 4 GPa;
the light transmitting substrate is characterised by a light transmittance transverse to the planar surface of at least 85%;
the light guiding apparatus is characterised by an absence of a cladding layer on its planar surface; and
the light guiding apparatus is characterised by an absence of a buffer layer on its planar surface.

25.-28. (canceled)

29. The see-through display according to claim 1, wherein one or more of:
the at least one light guiding apparatus is contacted with a first planar surface of the light valve; and
the light valve comprises a liquid crystal layer sandwiched between two electrode layers, and, optionally, wherein the electrode layer comprises indium tin oxide (ITO) and/or silicon on glass.

30.-31. (canceled)

32. The see-through display according to claim 1, wherein the see-through display further comprises a first polarizer stacked on the light valve, the polarizer optically connected with the light valve and, optionally, wherein the first polariser is contacted with a second surface of the light valve.

33. (canceled)

34. The see-through display according to claim 1, wherein the at least one light source is selected from a MEMS powered beam scanning engine, a linear array of lasers, LEDs, or a combination thereof.

35.-42. (canceled)

43. A method of fabricating a see-through display, comprising:
a) stacking a light valve on a surface of at least one light guiding apparatus such that the light valve is optically connected with the at least one light guiding apparatus, the at least one light guiding apparatus comprising:
i) a light transmitting substrate comprising a first edge, a second edge and a surface between the edges; and
ii) a plurality of light transflectors disposed on the surface or within the light transmitting substrate; and
b) disposing at least one light source adjacent to the first edge of the light transmitting substrate and optically connected with the at least one light guiding apparatus in order to transmit a light from the light source along a light path from the first edge towards the second edge,
wherein, when in use, each light transflector is configured to reflect a portion of the light away from the light path and to optionally transmit the other portion of the light along the light path.
